(19) United States
(12) Patent Application Publication
(10) Pub. No.: US 2006/0114185 A1
(43) Pub. Date: Jun. 1, 2006

(54) Plasma display and driving method thereof

(75) Inventors: Hyun Kim, Suwon-si (KR); Heung-Sik Tae, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/289,360

(22) Filed: Nov. 30, 2005

(30) Foreign Application Priority Data
Nov. 30, 2004 (KR) 10-2004-0098970

(51) Int. Cl. G09G 3/28

(52) U.S. Cl. 345/67

(57) ABSTRACT

A driving method of a plasma display, where in order to initialize a discharge cell having a larger distance between a scan electrode and a sustain electrode in the plasma display, a negative voltage is applied to the scan electrode and a positive voltage is applied to the address electrode so that a discharge occurs between the scan electrode and the address electrode. Next, the negative voltage is applied to the sustain electrode and the positive voltage is applied to the address electrode so that the discharge occurs between the sustain electrode and the address electrode. The voltage applied to the address electrode is reduced while the voltages applied to the scan electrode and the sustain electrode are maintained.

### CROSS-REFERENCE TO RELATED APPLICATIONS

This application claims the benefit of Korean Patent Application No. 2004-98970 filed in the Korean Intellectual Property Office on Nov. 30, 2004, the entire contents of which are incorporated herein by reference.

### BACKGROUND OF THE INVENTION

1. Field of the Invention

The present invention relates to a plasma display and a driving method thereof.

2. Description of the Related Art

A plasma display is a flat panel display that uses plasma generated by gas discharge to display characters or images. The plasma display includes, depending on its size, more than a few million pixels arranged in a matrix pattern.

Generally, one frame of the plasma display is divided into a plurality of subfields having respective weights, and each subfield includes a reset period, an address period, and a sustain period. The reset period is utilized for initializing the status of each discharge cell. The address period is utilized for selecting turn-on/turn-off cells (i.e., cells to be turned on or off). The sustain period is utilized for displaying an image on the turn-on cells during a period corresponding to the weights of the respective subfields.

It is known that such a plasma display has enhanced efficiency when a distance between discharge electrodes (a scan electrode and a sustain electrode) is large so that a positive column discharge is formed therebetween. However, the discharge electrodes are not usually allowed to have such a large distance in the plasma display since a discharge voltage increases proportionally to the distance between the discharged electrodes.

The above information disclosed in this Background section is only for enhancement of understanding of the background of the invention and therefore it may contain information that does not form the prior art that is already known in this country to a person of ordinary skill in the art.

### SUMMARY OF THE INVENTION

According to an aspect of the present invention, there is provided a plasma display and a driving method thereof having an advantage of placing discharge electrodes with a larger distance therebetween.

An exemplary plasma display according to an embodiment of the present invention includes a plasma display panel and a driver thereof. The plasma display panel includes a first electrode, a second electrode, and a third electrode formed in a direction crossing the first and second electrodes. The plasma display panel further includes a discharge cell formed by the first, the second, and the third electrodes. The driver applies a negative first voltage to the second electrode and a positive second voltage to the third electrode during a first period in a reset period, a negative third voltage to the first electrode and a positive fourth voltage to the second electrode during the second period in the reset period, and a positive fifth voltage to the third electrode during a third period, that is, a part of the second period.

In addition, an exemplary driving method of a plasma display according to an embodiment of the present invention is provided. The plasma display includes a plurality of first electrodes, a plurality of second electrodes, and a plurality of third electrodes formed in a direction crossing the first and second electrodes, and a plurality of discharge cells formed by the first, the second, and the third electrodes. According to the driving method, in a reset period, a negative first voltage is applied to the plurality of the second electrodes and a positive second voltage is applied to the plurality of the third electrodes. In addition, a negative third voltage is applied to the first electrodes, a positive fourth voltage is applied to the second electrodes, and a positive fifth voltage is applied to the third electrodes. Consecutively, voltages of the plurality of third electrodes are reduced to a sixth voltage lower than the fifth voltage while maintaining the plurality of first electrodes at the third voltage and the plurality of second electrodes at the fourth voltage.

According to another exemplary driving method of a plasma display, in a reset period, a first discharge may be formed between the second and the third electrodes and then a second discharge may be formed between the first and the third electrodes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a plasma display according to an exemplary embodiment of the present invention.

FIG. 2 is a partial top plan view of the plasma display panel of FIG. 1.

FIG. 3 is a cross-sectional view taken along a line III-III′ of FIG. 2.

FIG. 4 shows driving waveforms in a sustain period of the plasma display according to an exemplary embodiment of the present invention.

FIG. 5 is a schematic view for showing a discharge mechanism occurring when the driving waveforms of FIG. 4 are applied.

FIG. 6 shows driving waveforms in a reset period and an address period of the plasma display according to an exemplary embodiment of the present invention.

FIG. 7A to FIG. 7E show wall charge states in a cell according to the driving waveforms of FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The wall charges being described in the exemplary embodiment of the present invention represent charges formed on a wall close to each electrode of a discharge cell. The wall charge will be described as being “formed” or “accumulated” on the electrode, although the wall charges do not actually touch the electrodes. Further, a wall voltage represents a potential difference formed on the wall of the discharge cell by the wall charge.

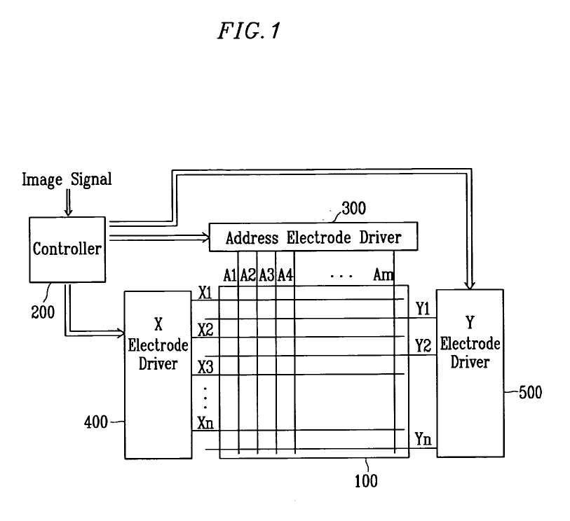

First of all, a configuration of a plasma display according to an exemplary embodiment of the present invention will be described with reference to FIG. 1 through FIG. 3.

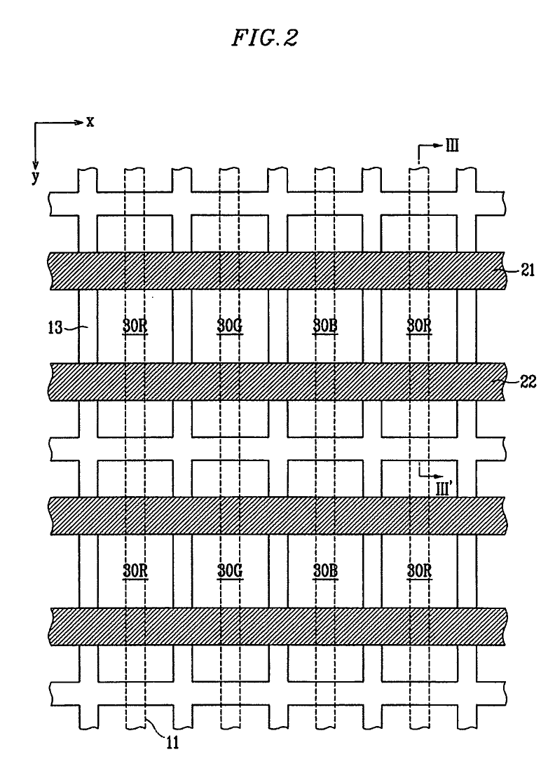

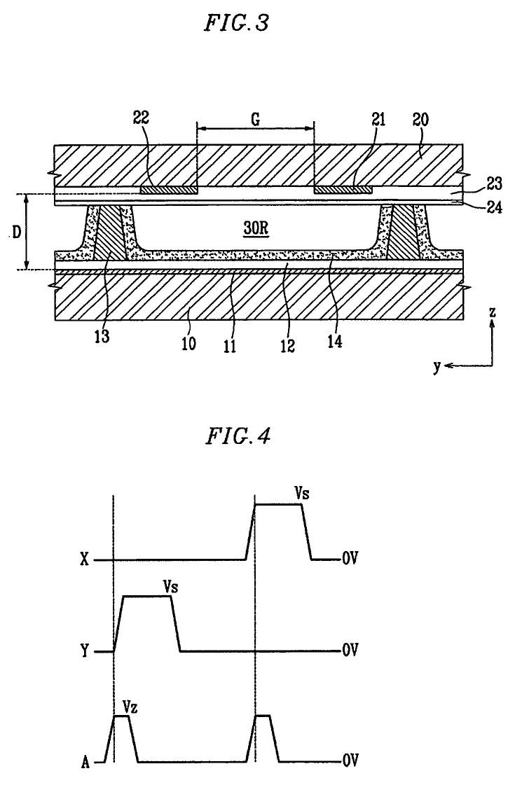

FIG. 1 shows a schematic diagram of the plasma display according to an exemplary embodiment of the present invention, FIG. 2 shows a partial top plan view of the plasma display panel of FIG. 1, and FIG. 3 shows a cross-sectional view taken along a line III-III′ of FIG. 2.

As shown in FIG. 1, a plasma display according to an exemplary embodiment of the present invention includes a plasma display panel (PDP) 100, a controller 200, an address electrode driver 300, a sustain electrode driver 400, and a scan electrode driver 500.

As shown in FIG. 1 and FIG. 2, the plasma display panel 100 includes a plurality of address electrodes (hereinafter called “A electrodes”) A1 to Am (refer to 11 in FIG. 2) extending in a column direction, a plurality of sustain electrodes (hereinafter called “X electrodes”) X1 to Xn (refer to 21 in FIG. 2) extending in a row direction, and a plurality of scan electrodes (hereinafter called “Y electrodes”) Y1 to Yn (refer to 22 in FIG. 2) extending in a row direction. The X electrodes 21 and the Y electrodes 22 are arranged in pairs. The X electrodes 21 are formed in respective correspondence to the Y electrodes 22, and the X and Y electrodes 21 and 22 are crossed by the A electrodes 11. The discharge spaces are formed at areas where the A electrodes 11 cross the X and Y electrodes, and such discharge spaces form discharge cells 30R, 30G, and 30B.

The controller 200 receives an external video signal and outputs an address driving control signal, a sustain electrode driving control signal, and a scan electrode driving control signal for driving the A, X, and Y electrode drivers 300, 400, and 500. In addition, the controller 200 controls the drivers 300, 400, and 500 by fields each of which is divided into a plurality of subfields having respective brightness weights.

In the address period, the Y electrode driver 500 applies a scan pulse to the Y electrodes 22 according to which of the Y electrodes 22 are selected. The A electrode driver 300 applies address voltages to respective A electrodes 11 for selecting discharge cells to be turned on whenever the scan pulse is applied to the Y electrode 22. That is, during the address period, cells to be turned on are selected by applying the address voltage to the A electrodes 11 thereof while sequentially applying the scan pulse to the Y electrodes 22. In addition, in the sustain period, the X electrode driver 400 and Y electrode driver 500 alternately apply a sustain discharge pulse to the X electrodes 21 and the Y electrodes 22 for displaying pictures at the addressed cells.

Hereinafter, the PDP 100 is described in detail with reference to FIG. 2 and FIG. 3. The PDP 100 includes a rear substrate 10 and a front substrate 20, which are opposite to each other with a predetermined distance therebetween.

As shown in FIG. 2 and FIG. 3, the plurality of A electrodes 11 covered with a dielectric layer 12 are extended along one direction (y-axis direction of FIG. 2 and FIG. 3) on the rear substrate 10. The A electrodes 11 are formed in parallel with each other with a predetermined interval therebetween.

Barrier ribs 13 are formed along one direction (the y-axis direction) in parallel with the A electrodes 11, and along another direction (the x-axis direction of FIG. 2 and FIG. 3) perpendicular thereto. The cells 30R, 30G, and 30B are partitioned by the barrier ribs 13 formed in such a lattice pattern. In addition, a phosphor layer 14 is formed on lateral sides of the barrier ribs 13 and on the dielectric layer 12. The red, green, and blue phosphor layers 14 are respectively formed in the cells 30R, 30G, and 30B, and colors of the cells 30R, 30G, and 30B are determined thereby. In addition, as shown in FIG. 2 and FIG. 3, although the barrier rib 13 is formed in a lattice pattern, the barrier rib 13 may be formed in a stripe pattern or another closed pattern.

On the front substrate 20, the X electrodes 21 and Y electrodes 22 extend along a direction (the x-axis direction of FIG. 2 and FIG. 3) crossing the A electrodes 11. In addition, a transparent dielectric layer 23 and a protective layer 24 are formed on the front substrate 20 and cover the X electrodes 21 and the Y electrodes 22. The protective layer 24 may be formed with an MgO material with a high secondary electron emission coefficient.

In addition, as shown in FIG. 3, the gap G between the X electrodes 21 and the Y electrodes 22 is formed to be longer than the distance D between the A electrodes 11 and the Y electrodes 22. Generally, such a structure is referred to as “a long gap structure.”

By such a long gap structure of discharge electrodes in the PDP, luminescence efficiency is improved since the positive column discharge occurs when a sustain discharge occurs between the X electrodes 21 and the Y electrodes 22. However, a driving method using the long gap structure is required to be different from the conventional driving method since a required voltage for a discharge between the X and Y electrodes 21 and 22 is higher.

A driving method of a plasma display having a long gap structure will be described with reference to FIG. 4 to FIG. 6 and FIG. 7A to FIG. 7E. For convenience of description, the driving method will be described based on only one cell formed with a single X electrode, a single Y electrode, and a single A electrode.

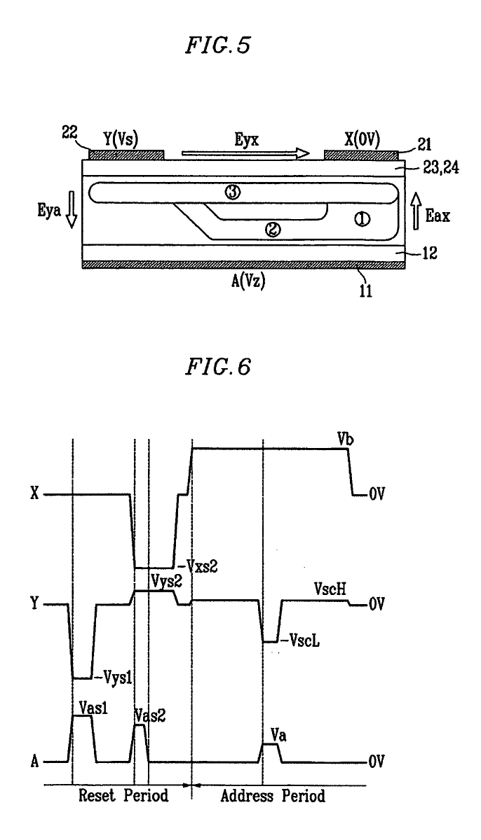

FIG. 4 shows driving waveforms in a sustain period of the plasma display according to an exemplary embodiment of the present invention, and FIG. 5 is a schematic view for showing a discharge mechanism occurring when the driving waveforms of FIG. 4 are applied. For convenience of description, the substrates 10 and 20, the barrier ribs 13, and the phosphor layer 14 are not illustrated in a cell of FIG. 5. Additionally, the dielectric layer 23 and the protective layer 24 are illustrated as only one layer and the X electrode 21 and the Y electrode 22 are illustrated on the dielectric layer 23.

First, before the sustain period, positive wall charges and negative wall charges are respectively formed on the Y electrode and the X electrode of the addressed cell. A smaller amount of the negative wall charges are formed on the A electrode than on the X electrode. In this embodiment, a sustain discharge pulse alternately has a Vs voltage and a ground voltage.

As shown in FIG. 4, a pulse of the Vs voltage is applied to the Y electrode, and simultaneously a pulse of the Vz voltage is applied to the A electrode while the X electrode is biased at the ground voltage. The pulse of the Vz voltage has a shorter width than that of the pulse of the Vs voltage. That is, the Vs voltage is applied to the Y electrode during a predetermined time after the voltage of the A electrode is changed from the Vz voltage to the ground voltage. In addition, the discharge firing voltage between the X electrode and the A electrode is lower than that between the X electrode and the Y electrode, since the X electrode covered with the protective layer having a high secondary electron emission coefficient acts as a cathode, and the gap between the X electrode and the A electrode is shorter than the distance between the X electrode and the Y electrode. Therefore, the Vz voltage may be set to be lower than the Vs voltage.

At this time, an induced discharge \textcircled{1} occurs between the A and X electrodes due to an electric field Eax between the A and X electrodes and an electric field Eyx between the Y and X electrodes, because a potential of the A electrode is set to be higher than that of the X electrode by the wall charge formed on the A electrode and the X electrode. That is, the distance between the X and Y electrodes is a long gap so that the discharge occurs between the A and X electrodes prior to that between the X and Y electrodes. Negative charges are accumulated on the phosphor layer 14 and dielectric layer 12 covering the A electrode by the induced discharge \textcircled{1} between the A and X electrodes, and the discharge \textcircled{2} expands along the A electrode.

When the expanding discharge \textcircled{2} reaches the Y electrode, the main discharge \textcircled{3} is formed between the Y and X electrodes. In addition, the electric field Eyx between the Y and X electrodes and the electric field Eya between the A and Y electrodes guides the discharge \textcircled{2} expanding along the A electrode toward the Y electrode so as to form the main discharge \textcircled{3}.

As described above, because the main discharge between the X and Y electrodes is caused by the induced discharge between the X and A electrodes according to an exemplary embodiment of the present invention, the Vs voltage for forming a discharge between the X and Y electrodes may be set to be lower than when the Vz voltage is not applied to the A electrode. For example, the Vs voltage and the Vz voltage may respectively be set to be 160V and 80V.

After the main discharge is formed between the X and Y electrodes, positive wall charges are accumulated on the X electrode applied with the ground voltage, and negative wall charges are accumulated on the Y electrode applied with the Vs voltage.

Next, as shown in FIG. 4, the pulse of the Vs voltage is applied to the X electrode and the pulse of the Vz voltage is applied to the A electrode while the Y electrode is biased at the ground voltage. As a result, as described above, the induced discharge \textcircled{1} occurs between the A and X electrodes, and the discharge \textcircled{2} expands to the Y electrode along the A electrode so that the main discharge \textcircled{3} occurs between the Y and X electrodes. The main discharge allows positive wall charges to be accumulated on the Y electrode and negative wall charges to be accumulated on the X electrode, so that the sustain discharge may occur again when the Vs voltage is applied to the Y electrode.

As described above, in the sustain period, the sustain pulse alternately having the Vs voltage and the ground voltage is applied to the Y and X electrodes in reverse phases. Accordingly, the sustain discharge may occur when the Vz voltage is applied to the A electrode at the time that the Vs voltage is applied to the Y electrode or the X electrode.

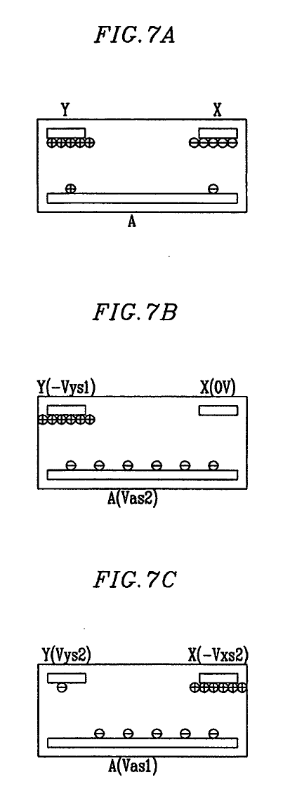

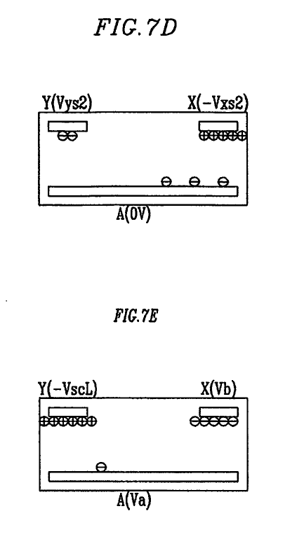

FIG. 6 shows driving waveforms in a reset period and an address period of the plasma display according to an exemplary embodiment of the present invention. FIG. 7A to FIG. 7E show the wall charge states in a cell according to the driving waveform of FIG. 6. For convenience of description, only the X electrode, the Y electrode, and the A electrode are illustrated in the cell.

Hereinafter, it is assumed that the sustain period of each subfield ends while the pulse of Vs voltage is applied to the X electrode. As shown in FIG. 7A, a cell that is turned on in the sustain period of the previous subfield has the positive wall charges on the Y electrode and the negative wall charges on the X electrode.

As shown in FIG. 6, a pulse of −Vys1 voltage is applied to the Y electrode and a pulse of Vas1 voltage is applied to the A electrode while the X electrode is biased at a ground voltage in a reset period. At this time, when a difference between the Vas1 voltage and −Vsy1 voltage is set to be sufficiently higher than the discharge firing voltage between the Y and A electrodes, a discharge occurs between the Y and A electrodes at the cell that is turned on in the previous subfield. As shown in FIG. 7B, this discharge forms the positive wall charges on the Y electrode and the negative wall charges on the A electrode.

Next, a pulse of a −Vxs2 voltage is applied to the X electrode, a pulse of a Vys2 voltage is applied to the Y electrode, and a pulse of a Vas2 voltage is applied to the A electrode. At this time, as shown in FIG. 7C, since the discharge mainly occurs between the X and A electrodes, negative wall charges are formed on the A electrode and positive wall charges are formed on the X electrode. In addition, the Vys2 voltage applied to the Y electrode partly forms the negative wall charge on the Y electrode.

Subsequently, the voltage applied to the A electrode is changed to the ground voltage while the X electrode and the Y electrode are respectively maintained at −Vxs2 voltage and Vys2 voltage. That is, the pulse of the Vas2 voltage has a shorter width than that of the pulses of the −Vxs2 voltage and the Vys2 voltage. In the wall charge state of FIG. 7C, since the potential difference in the cell is about 0V, the voltage change of the A electrode from the Vas2 voltage to the ground voltage produces effectively the same effect as that of the −Vas2 voltage applied to the A electrode. As a result, the wall charges are additionally formed on the A, X, and Y electrodes by a space charge temporarily remaining after the discharge of FIG. 7C, since the potential difference occurs between the A and Y electrodes and between the A and X electrodes. That is, positive wall charges are additionally formed on the A electrode having a relatively reduced potential, while negative wall charges are additionally formed on the X and Y electrodes having a relatively increased potential. Accordingly, the wall charges of the A and X electrodes become reduced and the wall charges of the Y electrode become increased as shown in FIG. 7D. At this time, the magnitude of the Vys2 voltage may be set to be smaller than the magnitude Vxs2 of the −Vxs2 voltage such that a strong discharge does not occur between the Y and A electrodes.

The reset period ends when the positive wall charges are formed on the X electrode and the negative wall charges are formed on the A and Y electrodes.

Next, in an address period, while the X electrode is biased at a Vb voltage, a pulse of a −VscL voltage is sequentially applied to the plurality of Y electrodes and a pulse of a Va voltage is applied to the A electrode of the turn-on cells among the cells formed on the Y electrode applied with the −VscL voltage. In addition, the Y electrodes not applied with the −VscL voltage are biased at a VscH voltage and the A electrodes not applied with the Va voltage are applied with the ground voltage. At this time, the ground voltage may be used as a VscH voltage. As a result, a weak discharge occurs between the Y electrode and the A electrode due to the −VscL voltage applied to the Y electrode and the Va voltage applied to the A electrode, and then a strong discharge occurs between the X electrode and the Y electrode due to the positive wall charges accumulated on the X electrode and the Vb voltage applied to the X electrode. Therefore, as shown FIG. 7E, the negative wall charges are uniformly formed on the X electrode and the positive wall charges are uniformly formed on the Y electrode so that the sustain discharge occurs in the sustain period.

In addition, the cells (i.e., turn-off cells), at which the discharge does not occur during the address period, are maintained at the wall charge state shown in FIG. 7D until before the reset period of the next subfield. At this time, the wall discharges may be partly eliminated according to a lapse of time.

As such, since the turn-off cells of the previous subfield have a wall charge state as shown in FIG. 7D, the turn-off cells of the previous subfield have a lower relative potential on the Y electrode than the turn-on cells of the previous subfield before the reset period. Therefore, when the −Vys1 voltage is applied to the Y electrode and the Vas1 voltage is applied to the A electrode in the reset period, a discharge occurs between the A and Y electrodes at the turn-off cells as at the turn-on cells of the previous subfield so that the turn off cells have the wall discharge state as shown in FIG. 7B. Accordingly, a discharge will occur at the turn-off cells and at the turn-on cells during the next reset period and the next address period.

Next, the voltage condition used in the reset period and the address period is described.

In the reset period, all the cells are initialized by the discharge between the Y electrode and the A electrode regardless of whether the cell is previously turned on or turned off, and then the discharge occurs between the X electrode and the A electrode. Therefore, a difference Vas1+Vys1 of the voltages externally applied for discharging between the Y electrode and the A electrode may be greater than the difference Vas2+Vxs2 of the voltages applied for discharging between the consecutive X electrode and the A electrode. In addition, in the reset period, the Vys2 voltage may be set to be lower than the Vs voltage or the Vz voltage such that the Vys2 voltage applied to the Y electrode does not cause the main discharge between the A electrode and the Y electrode.

In addition, in the address period, when the Va voltage is applied to the A electrode while the −VscL voltage is applied to the Y electrode, the discharge may occur between the A electrode and the Y electrode. However, in the sustain period, when the Vz voltage is applied to the A electrode while the ground voltage is applied to the Y electrode (or the X electrode), the discharge may occur between the A electrode and the Y electrode (or the X electrode). Therefore, the Va voltage may be set to be lower than the Vz voltage.

For example, the −Vys1 voltage may be set as −220V, the Vas1 voltage as 90V, the −Vxs2 voltage as −220V, the Vys2 voltage as 80V, the Vas2 voltage as 70V, the Vb voltage as 170V, the −VscL voltage as −120V, and the Va voltage as 40V.

According to an exemplary embodiment of the present invention, the plasma display can be driven at a relative low voltage even when the relative long gap is formed between the Y electrode and the X electrode. Accordingly, the plasma display can have enhanced efficiency since the power consumption can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display comprising:
a plasma display panel including a first electrode, a second electrode, and a third electrode formed in a direction crossing the first and second electrodes, the plasma display panel further including a discharge cell formed by the first, second, and third electrodes; and
a driver adapted to apply a negative first voltage to the second electrode and a positive second voltage to the third electrode during a first period in a reset period, applying a negative third voltage to the first electrode and a positive fourth voltage to the second electrode during a second period in the reset period, and applying a positive fifth voltage to the third electrode during a third period that is a part of the second period.

2. The plasma display of claim 1, wherein the driver applies a sixth voltage lower than the fifth voltage to the third electrode during a fourth period which is in the second period and other than the third period therein.

3. The plasma display of claim 2, wherein the third period is prior to the fourth period.

4. The plasma display of claim 3, wherein, in an address period, while biasing the first electrode at a positive seventh voltage, the driver respectively applies a negative eighth voltage and a positive ninth voltage to the second electrode and the third electrode of a turn-on discharge cell.

5. The plasma display of claim 4, wherein, in a sustain period, the driver applies a sustain pulse alternating between a tenth voltage and an eleventh voltage lower than the tenth voltage to the first electrode and the second electrode in inverted phases, and applies a positive twelfth voltage to the third electrode during a fifth period which is a part of the fourth period in which the tenth voltage is applied to the first electrode or the second electrode.

6. The plasma display of claim 5, wherein the fourth period is prior to the fifth period.

7. The plasma display of claim 6, wherein the driver applies the tenth voltage to the first electrode and the eleventh voltage to the second electrode at an end of the sustain period.

8. The plasma display of claim 6, wherein the twelfth voltage is lower than the tenth voltage.

9. The plasma display of claim 6, wherein the sixth voltage and the twelfth voltage are a ground voltage.

10. The plasma display of claim 5, wherein the twelfth voltage is higher than the ninth voltage.

11. The plasma display of claim 5, wherein the fourth voltage is lower than the tenth voltage.

12. The plasma display of claim 1, wherein a difference between the second voltage and the first voltage is greater than a difference between the fifth voltage and the third voltage.

13. The plasma display of claim 1, wherein a magnitude of the third voltage is larger than that of the fourth voltage.

14. The plasma display of claim 1, wherein a gap between the first electrode and the second electrode is longer than a distance between the second electrode and the third electrode.

15. A driving method of a plasma display comprising a plurality of first electrodes and a plurality of second electrodes, and a plurality of third electrodes formed in a direction crossing the pluralities of first and second electrodes, the plasma display further including a plurality of discharge cells formed by the pluralities of first, second, and third electrodes, the driving method comprising, in a reset period:
applying a negative first voltage to the plurality of second electrodes and a positive second voltage to the plurality of third electrodes,
applying a negative third voltage to the plurality of first electrodes and a positive fourth voltage to the plurality of second electrodes, and applying a positive fifth voltage to the plurality of third electrodes, and
reducing voltages of the plurality of third electrodes to a sixth voltage lower than the fifth voltage while maintaining the plurality of first electrodes at the third voltage and the plurality of second electrodes at the fourth voltage.

16. The driving method of claim 15, wherein a magnitude of the fourth voltage is smaller than that of the third voltage.

17. The driving method of claim 16, wherein a difference between the second voltage and the first voltage is greater than a difference between the fifth voltage and the third voltage.

18. The driving method of claim 15, wherein a gap between the first electrodes and the second electrodes is longer than a distance between the second electrodes and the third electrodes.

19. The driving method of claim 15, further comprising, in a sustain period, applying a sustain discharge pulse to the plurality of first electrodes and the plurality of second electrodes in inverted phases,
wherein, at an end of the sustain period, the plurality of first electrodes are applied with a voltage higher than a voltage applied to the plurality of second electrodes.

20. A driving method of a plasma display panel comprising a first electrode, a second electrode, and a third electrode formed in a direction crossing the first and second electrodes, the plasma display panel further comprising a discharge cell formed by the first, second, and third electrodes, the driving method comprising, in a reset period:
forming a first discharge between the second electrode and the third electrode; and
forming a second discharge between the first electrode and the third electrode.

21. The driving method of claim 20, wherein a gap between the first electrode and the second electrode is longer than a distance between the second electrode and the third electrode.

22. The driving method of claim 21, further comprising, in an address period, applying a scan pulse to the second electrode.

23. The driving method of claim 21, wherein, in the reset period, the first discharge is formed at each cell regardless of whether the cell is previously turned on or not.
